(19) United States
(12) Patent Application Publication
(10) Pub. No.: US 2008/0305400 A1
(43) Pub. Date: Dec. 11, 2008

(54) LITHIUM BATTERY OPERATING AT VERY LOW TEMPERATURE

(75) Inventors: Philippe BIENSAN, Carignan de Bordeaux (FR); Frederic Bonhomme, Mont de Marsan (FR); David Germond, Le Bouscat (FR); Jean-Marc Laluque, Castelnau de Medoc (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 11/955,820

(22) Filed: Dec. 13, 2007

(30) Foreign Application Priority Data
Dec. 20, 2006 (FR) 0611113

(51) Int. Cl. H01M 6/16

(52) U.S. Cl. 429/324; 252/182.1

(57) ABSTRACT

A composition useful as an electrolyte in a lithium-ion battery comprises at least one C₃-C₆ carbonate or a lactone, at least one unsaturated cyclic carbonate in a v/v proportion less than 5% of the volume of the other constituents of the composition, lithium hexafluorophosphate (LiPF6) and at least 0.2 mol/l lithium bis(oxalatoborate). A battery using this electrolyte is suitable for operation at temperatures down to about −50° C.

### FIELD OF THE INVENTION

The present invention relates to the field of lithium batteries.

### BACKGROUND ART

A lithium battery has an electrochemical bundle having a positive electrode comprising an electrochemically active material capable of inserting lithium into its structure (generally a transition-metal oxide, more often lithiated) and a negative electrode also capable of inserting lithium ions. The electrodes are placed on each side of a separating membrane generally made of polyolefin. The electrochemical bundle is impregnated with a solid or liquid non-aqueous electrolyte. The electrolyte contains a lithium salt dissolved in a mixture of organic solvents.

It is desirable to have available lithium-ion batteries capable of reaching a life span of at least 500 cycles during cycling at 4.2 V, having good low-temperature chargeability and dischargeability, as well as good capacity retention in high-temperature storage conditions.

The electrolyte has a marked impact on the irreversible loss of capacity of the battery. The irreversible loss of capacity of the battery is for example less marked when using an electrolyte comprising a mixture of ethyl carbonate/diethyl carbonate/dimethyl carbonate (EC/DEC/DMC) than for an electrolyte comprising a mixture of ethyl carbonate/dimethyl carbonate/ethyl acetate (EC/DMC/EA).

Addition of ethyl acetate has the drawback of reducing the cycle life span of the battery. In order to improve the cycle life span of the battery, a significant quantity of vinylene carbonate (VC) is added to the electrolyte, in general more than 4% v/v. For example, patent FR-B-2 787 243 describes an electrolyte for a lithium-ion battery constituted by an EC/DMC/EA/VC mixture in a proportion by volume of 14/24/57/5. It is stated that an electrolyte of this type allows the battery to be used at temperatures of less than or equal to −20° C.

Addition of significant quantities of vinylene carbonate (>4% v/v) however leads to a substantial drop in the battery voltage at the start of discharge at low temperatures.

Therefore a battery is sought which is suitable for operation at a low temperature, i.e. down to about −50° C. and which does not show a significant voltage drop at the start of discharge.

US Patent Application 2004/0076887 discloses an electrolyte composition for a lithium-ion battery. It is stated that this composition makes it possible to remedy the problem of the low ionic conductivity of lithium bis(oxalato)borate (LiBOB) when it is dissolved in a binary mixture of organic solvents. The electrolyte described in this document comprises:
lithium bis(oxalato)borate,
a cyclic carbonate,
one or more compounds chosen from acyclic carbonates, aliphatic esters, alicyclic ethers and difunctional aliphatic ethers,
one or more compounds chosen from lactones, dinitriles, compounds containing at least one carboxylic acid ester group and an ether group, compounds containing at least one carbonic acid ester group and an ether group, compounds containing at least one nitrile group and an ether group, trialkyl phosphoric acid esters and trialkyl boric acid esters.

German Patent Application DE-A-103 59 604 discloses an electrolyte composition for a lithium-ion battery. This electrolyte has a high ionic conductivity at low temperature. It comprises:
lithium bis(oxalato)borate,
a first dialkylcarbonate or an alkylene carbonate,
a second dialkyl carbonate or an alkylene carbonate,
a third dialkyl carbonate or an alkyl acetate,

US Patent Application US2005/0026044 discloses a lithium-ion battery, the electrolyte of which comprises:
one or more salts, including lithium bis(oxalato)borate,
one or more lactones, and
one or more low-viscosity solvents such as a linear carbonate or a linear ester. It is stated that an electrolyte of this type has a good ionic conductivity and that the battery has a long life span during cycling.

German Patent Application DE-A-103 46 651 discloses an electrolyte for a lithium-ion battery. This electrolyte comprises a salt of lithium bis(oxalato)borate salt and/or sodium hexafluorophosphate (LiPF₆) dissolved in a mixture comprising:
ethylene carbonate,
2-methylfurane and
at least one solvent chosen from the group comprising propylene carbonate, dimethyl carbonate, diethyl carbonate, ethyl methyl carbonate, butylene carbonate, ethyl acetate, methyl acetate, ethyl propionate and methyl propionate. The battery has an improved life span during cycling.

None of these documents resolves the problem of the significant voltage drop of a lithium battery at the start of a discharge at low temperature.

### SUMMARY OF THE INVENTION

A subject of the invention is a composition comprising.
at least one C₃-C₆ carbonate or a lactone,
at least one unsaturated cyclic carbonate in a v/v proportion of less than 5% of the volume of the other constituents of the composition,
lithium hexafluorophosphate (LiPF₆),
at least 0.2 mol/l lithium bis(oxalatoborate).

The invention rests on the discovery that the combination of the lithium hexafluorophosphate salt, the lithium bis(oxalatoborate) salt (LiBOB) and the unsaturated cyclic carbonate makes it possible to prevent the significant voltage drop of the lithium-ion battery at the start of discharge.

According to an embodiment, the composition comprises:
5 to 50% v/v of said at least one C₃-C₆ carbonate or of said lactone,
50 to 95% v/v of at least one linear ester of a C₂-C₈ saturated acid.

According to an embodiment, the v/v proportion of unsaturated cyclic carbonate

is greater than 0.5% of the volume of the other constituents of the composition.

According to an embodiment, the carbonate is a saturated cyclic carbonate. The saturated cyclic carbonate is chosen from ethylene carbonate, propylene carbonate, butylene carbonate or a mixture thereof. Preferably, the saturated cyclic carbonate is ethylene carbonate.

According to an embodiment, the composition moreover comprises a linear carbonate. The linear carbonate is chosen from dimethyl carbonate, diethyl carbonate, ethyl-methyl carbonate, methyl-propyl carbonate or a mixture thereof. Preferably, the linear carbonate is dimethyl carbonate.

According to an embodiment, the lactone is chosen from the group comprising gamma-butyrolactone and gamma-valerolactone or a mixture thereof.

According to an embodiment, the linear ester is chosen from ethyl acetate, methyl acetate, propyl acetate, ethyl butyrate, methyl butanoate, propyl butanoate, ethyl propionate, methyl propionate, propyl propionate. Preferably, the linear ester is ethyl acetate.

According to an embodiment, the unsaturated cyclic carbonate is vinylene carbonate.

According to an embodiment, the percentage v/v of unsaturated cyclic carbonate is less than or equal to 2%.

According to an embodiment, the proportion by volume of the C₃-C₆ carbonate or of the lactone is 10-40% and the proportion by volume of the linear ester is 60-90%.

According to an embodiment, the proportion by volume of the C₃-C₆ carbonate or of the lactone is 20-30% and the proportion by volume of the linear ester is 80-70%.

According to an embodiment, the composition comprises ethylene carbonate, dimethyl carbonate and ethyl acetate and the proportion by volume of the ethylene carbonate, dimethyl carbonate and ethyl acetate are respectively 10-20%, 20-30% and 50-70%.

According to an embodiment, the concentration of lithium bis(oxalatoborate) dissolved in the electrolyte is less than 0.5 mol/l.

According to an embodiment, the total concentration of the lithium salt is comprised between 1 mol/l and 1.5 mol/l.

According to an embodiment, the molar ratio of lithium bis(oxalatoborate) to lithium hexafluorophosphate is less than 1.

This composition can be used as electrolyte of a lithium-ion battery.

A subject of the invention is also a lithium-ion battery comprising the composition according to the invention as a liquid electrolyte.

The lithium-ion battery according to the invention is suitable for operation at temperatures down to about −50° C.

According to an embodiment, the lithium battery comprises:
at least one positive electrode containing a mixed oxide of lithium and a transition element such as Co, Ni and Mn.
at least one negative electrode containing an electrochemically active material which is a carbon suitable for inserting lithium ions, and
the previously-described composition as a liquid electrolyte.

According to a feature, the battery is suitable for operation at temperatures down to about −50° C.

A subject of the invention is therefore also the use of the battery at temperatures down to about −50° C.

The battery according to the invention can be used during cycling at ambient temperature for at least 500 cycles before the irreversible loss of capacity exceeds 20% of the initial capacity of the battery.

Finally, in high-temperature storage conditions (temperature less than or equal to 60° C.), the battery according to the invention presents a smaller irreversible loss of capacity than a lithium-ion battery of which the electrolyte does not contain lithium bis(oxalatoborate) salt.

### BRIEF DESCRIPTION OF THE DRAWINGS

FIG. 1 illustrates the irreversible loss of capacity of different types of lithium batteries subjected to a cycling test at ambient temperature; each cycle comprising a charge at rate C and a discharge at rate C/2. The cycling test is performed over approximately 700 cycles.

FIGS. 2A and 2B show the discharge curves of lithium-ion batteries at temperatures of −30° C. and −40° C. respectively, at rates C/5 and C.

FIG. 3 illustrates the irreversible loss of capacity for different types of batteries subjected to a high-temperature (40° C.) storage test. During this test, the batteries are kept at 40° C. at 4.2 V (“floating”). They are discharged periodically in order to monitor their capacity.

### DETAILED DESCRIPTION OF PREFERRED EMBODIMENTS

The principle of the invention rests on the discovery that the simultaneous presence of lithium hexafluorophosphate (LiPF₆), lithium bis(oxalatoborate) (LiBOB) and unsaturated cyclic carbonate allows the formation of a passivation layer on the negative electrode of the battery. Without wishing to be tied to theory, the Applicant believes that this passivation layer plays an important role in the polarisation of the negative electrode and that the change in the nature of the passivation layer makes it possible to obtain a higher discharge voltage of the battery at low temperature.

Lithium bis(oxalatoborate) (LiBOB), the formula for which is given below, contributes in a different manner to the formation of the passivation layer formed at the surface of the negative electrode.

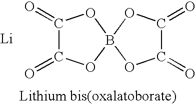

Part of the LiPF₆ is substituted by LiBOB.

The concentration of lithium bis(oxalatoborate) dissolved in the electrolyte is generally less than 0.5 mol/l.

According to an embodiment, the total concentration of lithium salt is comprised between 1 mol/l and 1.5 mol/l.

According to an embodiment, the concentration of LiPF₆ is comprised between 0.5 mol/l and 1.3 mol/l.

According to an embodiment, the molar ratio of lithium bisoxalatoborate to lithium hexafluorophosphate is less than 1.

According to an embodiment, the carbonate of the composition is a saturated cyclic carbonate. The saturated cyclic carbonate can be chosen from ethylene carbonate, propylene carbonate, butylene carbonate or a mixture thereof.

According to a preferred embodiment, the saturated cyclic carbonate is ethylene carbonate.

According to an embodiment, the composition comprises a linear carbonate. This linear carbonate can be chosen from dimethyl carbonate, diethyl carbonate, ethyl-methyl carbonate, methyl-propyl carbonate or a mixture thereof.

According to a preferred embodiment, the linear carbonate is dimethyl carbonate.

According to an embodiment, the composition comprises a lactone; this lactone can be chosen from the group comprising gamma-butyrolactone and gamma-valerolactone or a mixture thereof.

According to an embodiment, the composition contains a linear ester of a C₂-C₈ saturated acid. The incorporation of at least one linear ester of a C₂-C₈ saturated acid increases the discharged capacity at low temperature, especially for high discharge currents, i.e. discharge currents higher than C/1, C being the nominal capacity of the battery.

By linear ester of a saturated acid or a saturated aliphatic carboxylate is generally meant a compound of formula R—CO—OR′ in which R is H or an alkyl group and R′ is an alkyl group such as CH₃ (methyl), CH₃—CH₂ (ethyl), etc. Said linear ester of a saturated aliphatic monocarboxylic acid is for example a formate if R is H, an acetate if R is CH₃, a propionate if R is CH₃—CH₂, a butyrate if R is CH₃—(CH₂)₂, a valerate if R is CH₃—(CH₂)₃, etc.

The linear ester can be chosen from ethyl acetate, methyl acetate, propyl acetate, ethyl butyrate, methyl butanoate, propyl butanoate, ethyl propionate, methyl propionate, propyl propionate.

According to a preferred embodiment, the linear ester is ethyl acetate.

Compounds such as vinylene carbonate (VC) and its derivatives, in particular propylidene carbonate, ethylidene ethylene carbonate, isopropylidene ethylene carbonate, belong to the family of unsaturated cyclic carbonates. By derivatives of vinylene carbonate is meant compounds having at least one unsaturated bond to a carbon atom of the cycle, such as for example, propylidene carbonate, ethylene ethylidene carbonate (or 4-ethylidene 1-3 dioxolane-2-one), or isopropylidene ethylene carbonate (or 4-isopropylidene 1-3 dioxolane-2-one).

According to an embodiment, the unsaturated cyclic carbonate is vinylene carbonate. The composition according to the invention allows the quantity of unsaturated cyclic carbonate to be reduced. The composition according to the invention contains a proportion of unsaturated cyclic carbonate less than 5% v/v of the volume of the other constituents. Preferably, the percentage v/v of the unsaturated cyclic carbonate is less than or equal to 2%.

According to an embodiment, the v/v proportion of unsaturated cyclic carbonate is greater than 0.5% of the volume of the other constituents of the composition.

According to an embodiment, the composition comprises:
5 to 50% v/v of said at least one C₃-C₆ carbonate or of said lactone,
50 to 95% v/v of at least one linear ester of a C₂-C₈ saturated acid.

According to an embodiment, the proportion by volume of the C₃-C₆ carbonate or of the lactone is 10-40% and the proportion by volume of the linear ester is 60-90%.

According to an embodiment, the proportion by volume of the C₃-C₆ carbonate or of the lactone is 20-30% and the proportion by volume of the linear ester is 80-70%.

According to a preferred embodiment, the composition contains ethylene carbonate, dimethyl carbonate and ethyl acetate, and the proportion by volume of ethylene carbonate, dimethyl carbonate and ethyl acetate are respectively 10-20%, 20-30% and 50-70%.

The composition according to the invention is used as electrolyte of a lithium battery. This battery typically comprises:
at least one positive electrode containing a mixed oxide of lithium and a transition element such as Co, Ni and Mn,
at least one negative electrode containing an electrochemically active material which is a carbon suitable for inserting lithium ions,
the composition according to the invention as a liquid electrolyte.

The binder of the negative electrode preferably comprises a non-fluorinated polymer chosen from: styrene and butadiene copolymer, acrylonitrile and butadiene copolymer, acrylic acid homopolymer, carboxymethylcellulose and mixtures thereof.

According to an embodiment, the polymer is a mixture of a styrene and butadiene copolymer and carboxymethylcellulose. Preferably, the proportion by weight of the styrene and butadiene copolymer is comprised between 30 and 70% of said binder and the proportion by weight of carboxymethylcellulose is comprised between 30 and 70% of said binder.

The battery according to the invention is suitable for operation at temperatures down to about −50° C. It has not only a high voltage on discharge at a low temperature (that can fall as low as −50° C.) but also a good cycling life span at ambient temperature. In fact, a battery of this type has an irreversible loss of capacity less than or equal to 20% after 500 cycles.

A subject of the present invention is also the use of a generator of this type at temperatures that can fall as low as −50° C.

Other characteristics and advantages of the present invention will become apparent from

the following example embodiments given by way of illustration and non-limitatively.

### EXAMPLES

The impact of different electrolyte compositions on the cycling life span as well as on low-temperature performance values was assessed. The electrolyte compositions tested are listed in Table 1.

TABLE 1
Compositions of the tested electrolytes

| | | Proportion by volume of | | |
|---|---|---|---|---|
| Reference of the | Proportion by volume of | VC (unsaturated cyclic | LiPF₆ concentration | LiBOB concentration |
| composition | carbonate and ester | carbonate) | (mol/l) | (mol/l) |
| A | EC/DMC/EA (15/25/60) | 2% | 1.5 | 0 |
| B | EC/DMC/EA (15/25/60) | 5% | 1.5 | 0 |
| C | EC/DMC/EA (15/25/60) | 2% | 1 | 0.05 |
| D | EC/DMC/EA (15/25/60) | 2% | 1.4 | 0.1 |
| E | EC/DMC/EA (15/25/60) | 0% | 1.25 | 0.25 |
| F | EC/DMC/EA (15/25/60) | 2% | 1.25 | 0.25 |

Compositions A and B do not contain LiBOB. Therefore they do not form part of the invention.

Compositions C and D contain LiBOB in a concentration less than 0.2 mol/l. Therefore they do not form part of the invention.

Composition E does not contain unsaturated cyclic carbonate. Therefore it does not form part of the invention.

Composition F is a composition according to the invention.

The tests were carried out with electrochemical units of nominal capacity 2.7 Ah and voltage of 4.2V in the charged state. The LiCoO₂-based positive electrode is identical in all units. The negative electrode is graphite-based.

### Description of the Tests Carried Out:

a) The cycling test at ambient temperature was carried out at a rate C on charge and C/2 on discharge in a voltage ranging from 2.7 to 4.2V.

b) The low-temperature cycling test was carried out as follows: Charge C/5 at ambient temperature, discharge at C/5 or C at −30° C. or −40° C.

c) The storage test was carried out placing the batteries in an enclosure at 40° C. The batteries are kept at 4.2V. Their capacity is measured at ambient temperature after 15, 30, 60, 89 and 120 days of storage.

### Results

a) Cycle Life Span Test at Ambient Temperature:

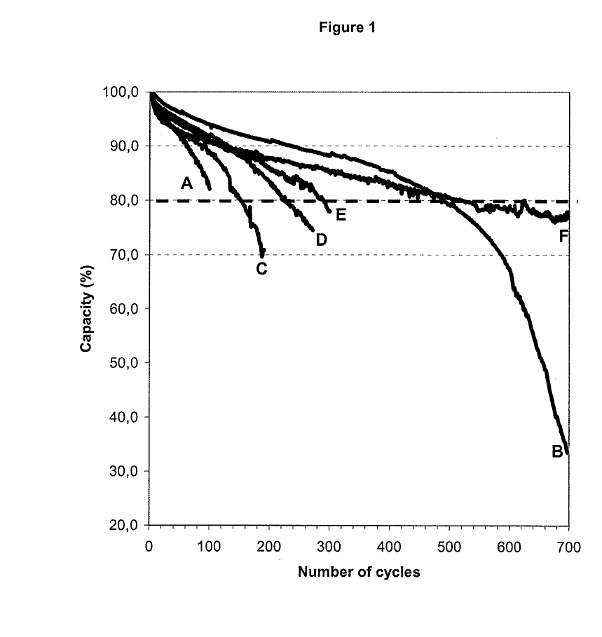

FIG. 1 shows that the use of an electrolyte containing 0.25 mol/l LiBOB and 2% VC (Electrolyte F) makes it possible to achieve a cycling life span of 500 cycles for a loss of capacity of 20%. This result is equivalent to that obtained with an electrolyte containing 5% vinylene carbonate but no LiBOB. (Electrolyte B).

The battery comprising electrolyte F according to the invention has a life span substantially greater than batteries A, C and D which either do not contain LiBOB, or do contain it, but in insufficient quantity.

The battery comprising electrolyte F according to the invention has a much longer life span than battery E the electrolyte of which does not contain vinylene carbonate.

b) Low-Temperature Performance Test:

Performance values on discharge at C/5 and C at −30° C. of a battery comprising electrolyte F are compared with those of:
a battery the electrolyte of which contains 5% vinylene carbonate but does not contain LiBOB (Electrolyte B),
a battery the electrolyte of which contains 2% vinylene carbonate but does not contain LiBOB (Electrolyte A),

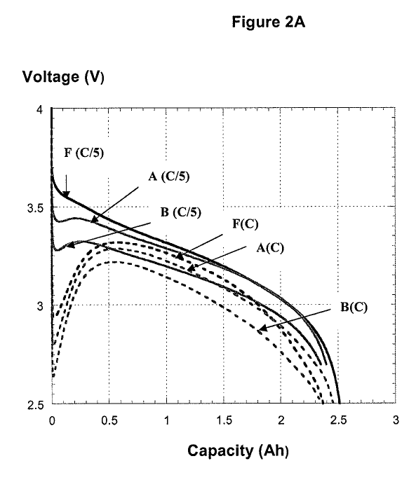

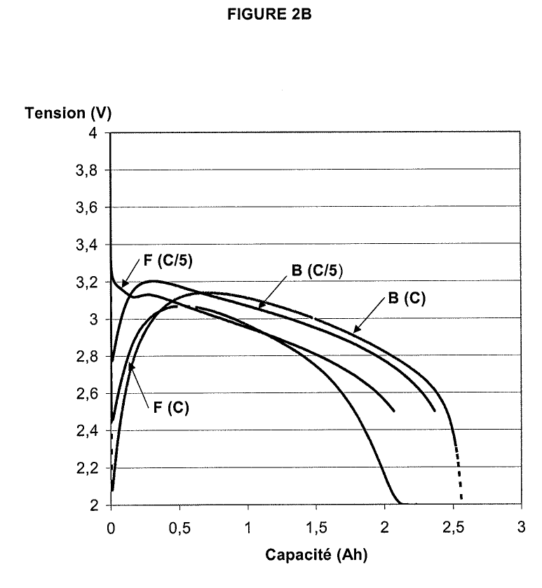

The results of the test are shown in FIG. 2A. For discharge at rate C/5, the voltage of the battery with electrolyte F is greater than that of batteries A and B. Moreover, the voltage of the battery comprising electrolyte F does not drop suddenly.

For the more rapid discharge at rate C, the voltage of the battery with electrolyte F is greater than that of the batteries comprising electrolytes A and B.

Discharge performances at C/5 and C at −40° C. of a battery comprising electrolyte F are compared with those of a battery the electrolyte of which contains 5% vinylene carbonate but does not contain LiBOB (Electrolyte B),

The test results are shown in FIG. 2B. for the discharges at currents C/5 and C, the battery comprising electrolyte F has a smaller voltage drop at the start of discharge than the battery comprising electrolyte B.

c) Test of Capacity of the Batteries During Storage in the Charged State at 4.2V at 40° C.

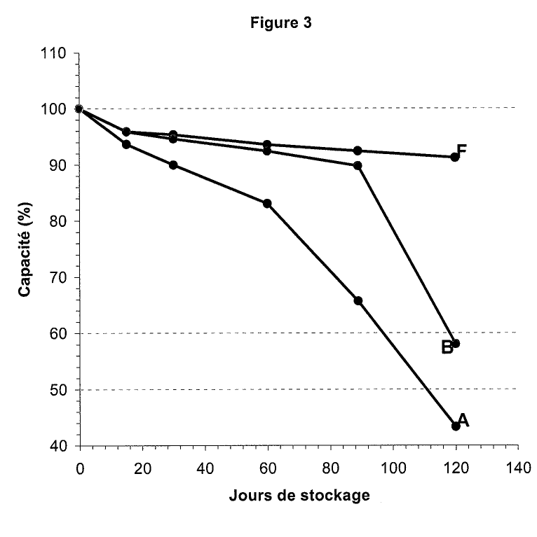

The results of the test are shown in FIG. 3. The loss of capacity of the battery comprising electrolyte F is slow. This loss of capacity is only approximately 10% after 120 days of storage.

In contrast, the battery comprising electrolyte A with 2% VC shows a rapid drop in its capacity from the start of the test. After 120 days of storage, the loss of capacity of the battery is 55%. In the same conditions, the loss of capacity of the battery comprising electrolyte B after 120 days of storage is approximately 40%.

In conclusion, the battery comprising electrolyte F makes it possible to combine a good life span, good low-temperature performances and a reduced loss of capacity in storage, compared with an electrolyte which does not contain LiBOB.

1-23. (canceled)

24. A composition comprising:
at least one C₃-C₆ carbonate or a lactone,
at least one unsaturated cyclic carbonate in a v/v proportion less than 5% of the volume of the other constituents of the composition,
lithium hexafluorophosphate (LiPF6),
at least 0.2 mol/l lithium bis(oxalatoborate).

25. The composition according to claim 24, comprising.
5 to 50% v/v of said at least one C₃-C₆ carbonate or of said lactone,
50 to 95% v/v of at least one linear ester of a C₂-C₈ saturated acid.

26. The composition according to claim 24, in which the v/v proportion of unsaturated cyclic carbonate is greater than 0.5% of the volume of the other constituents of the composition.

27. The composition according to claim 24, in which the carbonate is a saturated cyclic carbonate.

28. The composition according to claim 27, in which the saturated cyclic carbonate is chosen from ethylene carbonate, propylene carbonate, butylene carbonate or a mixture thereof.

29. The composition according to claim 28, in which the saturated cyclic carbonate is ethylene carbonate.

30. The composition according to claim 24, also comprising a linear carbonate.

31. The composition according to claim 30, in which the linear carbonate is chosen from dimethyl carbonate, diethyl carbonate, ethyl-methyl carbonate, methyl-propyl carbonate or a mixture thereof.

32. The composition according to claim 31, in which the linear carbonate is dimethyl carbonate.

33. The composition according to claim 24, in which the lactone is chosen from the group comprising gamma-butyrolactone and gamma-valerolactone or a mixture thereof.

34. The composition according claim 25, in which the linear ester is chosen from ethyl acetate, methyl acetate, propyl acetate, ethyl butyrate, methyl butanoate, propyl butanoate, ethyl propionate, methyl propionate, propyl propionate.

35. The composition according to claim 34, in which the linear ester is ethyl acetate.

36. The composition according to claim 24, in which the unsaturated cyclic carbonate is vinylene carbonate.

37. The composition according to claim 24, in which the percentage v/v of unsaturated cyclic carbonate is less than or equal to 2%.

38. The composition according to claim 25, in which the proportion by volume of the C₃-C₆ carbonate or of the lactone is 10-40% and the proportion by volume of the linear ester is 60-90%.

39. The composition according to claim 25, in which the proportion by volume of the C₃-C₆ carbonate or of the lactone is 20-30% and the proportion by volume of the linear ester is 80-70%.

40. The composition according to according to claim 25, comprising ethylene carbonate, dimethyl carbonate and ethyl acetate and in which the proportion by volume of the ethylene carbonate, dimethyl carbonate and ethyl acetate are respectively 10-20%, 20-30% and 50-70%.

41. The composition according to claim 24, in which the concentration of lithium bis(oxalatoborate) dissolved in the electrolyte is less than 0.5 mol/l.

42. The composition according to claim 24, in which the total concentration of lithium salt is comprised between 1 mol/l and 1.5 mol/l.

43. The composition according to claim 24, in which the molar ratio of lithium bis(oxalatoborate) to lithium hexafluorophosphate is less than 1.

44. A lithium battery comprising:
at least one positive electrode containing a mixed oxide of lithium and a transition element such as Co, Ni and Mn.
at least one negative electrode containing an electrochemically active material which is a carbon suitable for inserting lithium ions, and a composition comprising:
at least one C₃-C₆ carbonate or a lactone,
at least one unsaturated cyclic carbonate in a v/v proportion less than 5% of the volume of the other constituents of the composition,
lithium hexafluorophosphate (LiPF6),
at least 0.2 mol/l lithium bis(oxalatoborate)
as a liquid electrolyte.

45. The battery according to claim 44, suitable for operation at temperatures down to about −50° C.

46. The use of a lithium battery comprising:
at least one positive electrode containing a mixed oxide of lithium and a transition element such as Co, Ni and Mn.
at least one negative electrode containing an electrochemically active material which is a carbon suitable for inserting lithium ions, and a composition comprising:
at least one C₃-C₆ carbonate or a lactone,
at least one unsaturated cyclic carbonate in a v/v proportion less than 5% of the volume of the other constituents of the composition,
lithium hexafluorophosphate (LiPF6),
at least 0.2 mol/l lithium bis(oxalatoborate)
as a liquid electrolyte, at temperatures down to about −50° C.
